(19) United States
(12) Patent Application Publication
(10) Pub. No.: US 2025/0251483 A1
(43) Pub. Date: Aug. 7, 2025

(54) RESOURCE-EFFICIENT WIRELESS RANGING AND LOCALIZATION TECHNIQUES

(71) Applicant: Cisco Technology, Inc., San Jose, CA (US)

(72) Inventors: Jerome HENRY, Pittsboro, NC (US); Robert E. BARTON, Richmond (CA); Peiman AMINI, Fremont, CA (US); Ardalan ALIZADEH, Campbell, CA (US); Rabe ARSHAD, Milpitas, CA (US)

(21) Appl. No.: 18/430,536

(22) Filed: Feb. 1, 2024

(51) Int. Cl. G01S 5/00; G01S 5/02

(52) U.S. Cl. CPC G01S 5/017; G01S 5/019; G01S 5/0268

(57) ABSTRACT

Techniques for improved localization and ranging with reduced resource consumption are provided. At a first time, first movement information for a client device is determined. Based on the first movement information, a first set of localization parameters is selected. One or more localization techniques are performed in accordance with the first set of localization parameters. At a second time, second movement information for the client device is determined. Based on the second movement information, a second set of localization parameters is selected. One or more localization techniques are performed in accordance with the second set of localization parameters.

### TECHNICAL FIELD

Embodiments presented in this disclosure generally relate to wireless ranging and localization. More specifically, embodiments disclosed herein relate to more resource-efficient wireless ranging and localization.

### BACKGROUND

A variety of wireless Access Points (APs) have the ability to facilitate or perform ranging or localization with client devices. For example, internal Bluetooth low energy (BLE) radios may be used for received signal strength indicator (RSSI)-based asset tracking. Some client devices (which may include user devices such as smartphones, and/or dedicated asset tags) are designed to use multiple techniques or technologies for ranging. For example, some devices can perform long-range ranging using lower power BLE methods such as RSSI or time of flight (ToF) (e.g., using High Accuracy Distance Measurement (HADM)), as well as more precise ranging using technologies such as ultra-wideband (UWB).

Generally, when wireless tags or other client devices are used for ranging and/or location tracking, these devices rely on battery power (e.g., because the devices are generally free to move around the room). Ranging often consumes substantial energy in conventional systems. This power consumption is particularly notable for dedicated asset tags (whose primary or sole function is ranging). While ranging techniques have improved considerably in their accuracy, existing techniques can rapidly drain the devices' batteries. For example, experiments have shown that a coin cell battery (e.g., a CR2032 battery) lasts only for a single day when used to power a UWB tag performing two-way ranging.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for efficient ranging and localization, according to some embodiments of the present disclosure.

FIG. 2 is a flow diagram depicting an example method for selecting parameters for efficient ranging and localization, according to some embodiments of the present disclosure.

FIG. 3 is a flow diagram depicting an example method for evaluating accelerometer data to select efficient ranging parameters, according to some embodiments of the present disclosure.

FIG. 4 is a flow diagram depicting an example method for location-based ranging parameter selection, according to some embodiments of the present disclosure.

FIG. 5 is a flow diagram depicting an example method for refining ranging mappings, according to some embodiments of the present disclosure.

FIG. 6 is a flow diagram depicting an example method for performing localization, according to some embodiments of the present disclosure.

FIG. 7 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, comprising: determining, at a first time, first movement information for a client device; selecting, based on the first movement information, a first set of localization parameters; performing one or more localization techniques in accordance with the first set of localization parameters; determining, at a second time, second movement information for the client device; selecting, based on the second movement information, a second set of localization parameters; and performing one or more localization techniques in accordance with the second set of localization parameters.

One embodiment presented in this disclosure provides one or more non-transitory computer-readable media comprising computer-executable instructions that, when executed by one or more processors of a processing system, cause the processing system to perform an operation comprising: determining, at a first time, first movement information for a client device; selecting, based on the first movement information, a first set of localization parameters; performing one or more localization techniques in accordance with the first set of localization parameters; determining, at a second time, second movement information for the client device; selecting, based on the second movement information, a second set of localization parameters; and performing one or more localization techniques in accordance with the second set of localization parameters.

One embodiment presented in this disclosure provides a system comprising: one or more computer processors; and logic encoded in one or more non-transitory media, the logic collectively executable by operation of the one or more computer processors to perform an operation comprising: determining, at a first time, first movement information for a client device; selecting, based on the first movement information, a first set of localization parameters; performing one or more localization techniques in accordance with the first set of localization parameters; determining, at a second time, second movement information for the client device; selecting, based on the second movement information, a second set of localization parameters; and performing one or more localization techniques in accordance with the second set of localization parameters.

### EXAMPLE EMBODIMENTS

Embodiments of the present disclosure provide techniques and architectures for improved wireless ranging techniques with reduced power consumption.

In some embodiments, based on a variety of movement characteristics or information, client devices can dynamically select ranging parameters (also referred to as localization parameters in some embodiments) to enable sufficiently accurate and reliable ranging with reduced power consumption. Generally, the movement information can include a variety of data, such as whether the client device is moving, how the client device is moving (e.g., how quickly it is accelerating and/or moving, which direction it is accelerating and/or moving, and the like), the location of the client device in a physical space, and the like.

For example, in some embodiments, when the client device is motionless, it is not necessary to continually measure its location (which consumes substantial energy). Many client devices will be motionless for much of their lifetimes (e.g., for dedicated tracking tags attached to shipping packaging or other hardware in a warehouse). In some embodiments, therefore, location measurements may be taken only when such devices are in motion, which can greatly extend the device's battery life. As another example, even energy efficient ranging between an AP and a device can consume excessive energy, especially if multiple ranging techniques (e.g., UWB, HADM, RSSI, and the like) are independently employed and/or if the frequency of ranging is too aggressive. In some embodiments, therefore, ranging may be performed using a selected subset of technologies and/or at reduced rates.

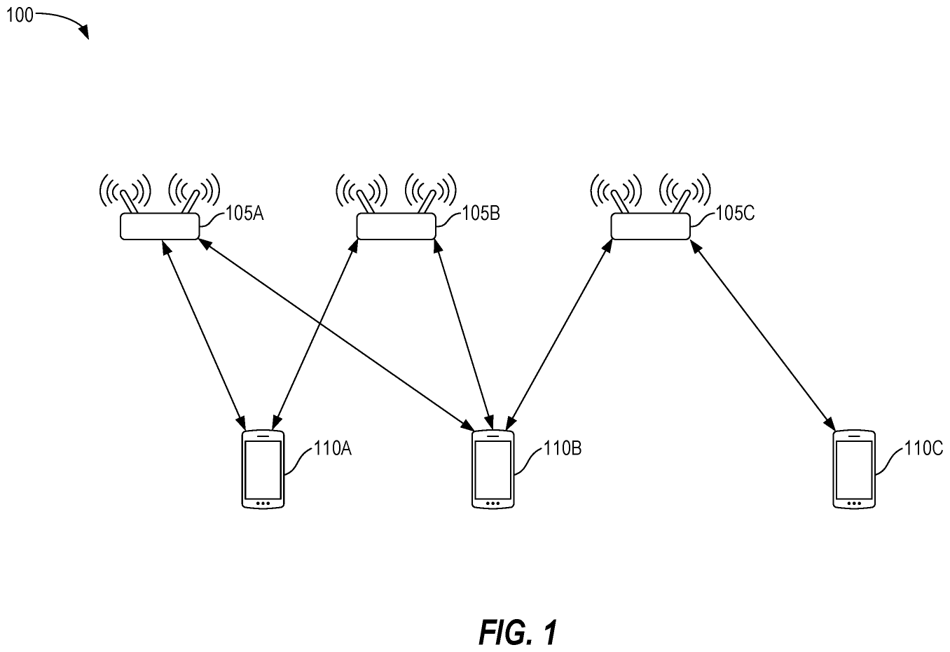

FIG. 1 depicts an example environment 100 for efficient ranging and localization, according to some embodiments of the present disclosure.

The illustrated environment includes a set of APs 105A-C (also referred to as anchors in some aspects) and a set of client devices 110A-C (also referred to as stations, STAs, and/or tags in some aspects). In the illustrated example, the APs 105 may generally be used to provide or host a wireless local area network (WLAN), such as a WiFi network. For example, client devices 110 may connect or associate to the APs 105, using the APs 105 to exchange data among the client devices 110 and/or with other devices outside of the network (e.g., where the APs 105 enable connectivity to one or more broader networks, such as the Internet).

Although the illustrated example depicts three APs 105 and three client devices 110, in embodiments, there may be any number and variety of APs 105 and client devices 110. In the illustrated example, the client devices 110 are user devices (e.g., smartphones). However, the client devices 110 may generally include any computing devices capable of performing wireless ranging (also referred to as wireless localization), such as dedicated tracking tags. In some embodiments, the terms “ranging” and “localization” may be used interchangeably. Generally, ranging refers to determining or inferring the distance between a first device (e.g., a client device 110) and a second device (e.g., an AP 105), while localization refers to determining or inferring the location of a first device (e.g., a client device 110) based on ranging to multiple other devices (e.g., a set of APs 105 having known locations).

Generally, a wide variety of ranging or localization techniques may be used by the client devices 110. For example, the client devices 110 may use angle of arrival (AoA) and/or angle of departure (AoD)-based ranging, ToF-based ranging, RSSI-based ranging, and the like. In some embodiments, some or all of the client devices 110 may perform ranging to the APs 105 periodically (e.g., once per hour), continuously (e.g., every few seconds), in response to various events (e.g., in response to a user or other system triggering a ranging operation, or in response to determining that the device has moved), and the like.

In some embodiments, as discussed below in more detail, one or more of the client devices 110 may evaluate various location and/or movement information in order to select ranging parameters to more efficiently perform localization with reduced power consumption. Generally, the ranging or localization parameters may include a variety of alternatives, such as a ranging or localization frequency (e.g., how often to perform ranging), selecting one or more specific localization techniques (e.g., determining to refrain from using one or more techniques for at least one localization operation), selecting a number of other devices to which the client device 110 should range for one or more localization operations, and the like.

In some embodiments, one or more of the client devices 110 and/or APs 105 may only initiate ranging when localization is actually needed. For example, if a client device 110 is not moving or has not moved, there may be no need to reinitiate a ranging evaluation.

In some embodiments, one or more client devices 110 may use motion-based triggered ranging. For example, many client devices 110 include (or can support) one or more accelerometers (e.g., a tri-axis accelerometer). As one example, most mobile smartphones have accelerometers. In some embodiments, when the accelerometer oscillates (indicating motion of the client device 110), the client device 110 may trigger a new ranging function or iteration to determine the updated location. However, in some embodiments, when the accelerometer indicates that the client device 110 is still or not moving, the client device 110 may refrain from triggering or initiating a ranging operation. Generally, a variety of techniques may be used to perform motion detection. For example, the client device 110 may evaluate RSSI of various APs 105 and/or radios, accelerometer data, and the like. In some embodiments, the client device 110 may use temperature to infer motion. For example, if the detected temperature (e.g., detected using a thermometer component of the client device 110) changes rapidly (e.g., a change above a threshold over a defined period of time), the client device 110 may infer that the device is in motion.

In some embodiments, in addition to or instead of using a binary motion detection determination to turn ranging on and/or off, the client device 110 may switch or select ranging techniques or technologies based on whether movement is detected. For example, if the client device 110 determines that it is moving, the client device 110 may determine to use ranging techniques such as UWB-based or HADM, which generally provide more accurate tracking (at the cost of increased power or energy consumption). Conversely, if the client device 110 determines that it is stationary, the client device 110 may determine to use other techniques such as BLE (e.g., RSSI-based ranging), which are generally less accurate (but consume reduced energy or power). That is, the client device 110 may evaluate its own motion to switch between different types of ranging.

In some embodiments, available motion detectors (e.g., accelerometers) may produce relatively noisy data. In some embodiments, therefore, the client device 110 may determine a set of motion parameters (in addition to or instead of a binary indication of movement), such as a likelihood or probability of device motion with associated characteristics (e.g., at a given speed, in a given direction, with a given amplitude, and the like). In some embodiments, if the determined motion likelihood is below a configurable threshold, the client device 110 may refrain from ranging. However, in some embodiments, movement uncertainty may accumulate over time (causing the client device 110 to be unsure whether it has moved or not). In some embodiments, therefore, after a defined interval of time has passed without performing ranging, the client device 110 may determine to initiate one or more ranging operations.

In some embodiments, if motion has not been detected, the client device 110 may use a set of ranging parameters to reduce energy consumption, such as ranging to a single AP 105 as a reference point (e.g., a UWB anchor). In some embodiments, if the client device 110 determines that its range to the single AP 105 has not changed (e.g., if the most recent single-anchor range is different from the previous range to the same AP 105), the client device 110 may determine that the probability that the client device 110 has not moved is increased. In response, the client device 110 may return to a “no ranging measurement” state or phase. In some embodiments, if the range to the AP 105 has changed, the client device 110 may determine that the likelihood of movement is higher. In response, the client device 110 may determine to perform more complete ranging measurements using more robust settings (which may consume additional resources). For example, the client device 110 may range against multiple APs 105.

In some embodiments, location tracking or ranging can be executed or initiated by either the infrastructure (e.g., through one or more APs 105) or by a client device 110. In some cases, the infrastructure (e.g., a controller or other system) may periodically reevaluate the location(s) of one or more client devices 110 (in addition to or instead of the client device 110 determining its own location). In some embodiments, if the client device 110 is stationary, the infrastructure may similarly refrain from performing continual ranging in in order to preserve the device's battery. In some embodiments, therefore, when a client device 110 detects motion (e.g., using an accelerometer), the client device 110 may transmit a management frame to the AP(s) 105, including an information element (IE) to inform the ranging infrastructure that the client device 110 is in motion. In some embodiments, in response to receiving this trigger, the infrastructure (e.g., one or more APs 105) may begin or initiate a new ranging operation to the client device 110.

In some embodiments, the management frame may further include elements such as the range of or direction of the motion, the acceleration of the motion, the speed of the motion, and the like. In some embodiments, in addition to or instead of transmitting a management frame (e.g., over WiFi), the client device 110 may send another specialized message over other modalities or types of technology (e.g. via Bluetooth, UWB, and the like).

In some embodiments, rather than sending a specialized frame to indicate motion, the client device 110 may additionally or alternatively transmit a ranging frame to the AP(s) 105. In some such embodiments, the infrastructure system(s) may interpret this ranging frame as an indication that the client device 110 position may have changed (e.g., the AP 105 may infer that the internal accelerometer of the client device 110 indicates movement, hence the ranging frame). In response, the AP 105 may determine to refresh its own location information as well (e.g., determine to perform a ranging operation to the client device 110 as well).

In some embodiments, in addition to or instead of using binary motion detection to select ranging parameters, the client device 110 and/or APs 105 may use a graduated motion-based ranging approach. For example, based on the rate of motion (e.g., as determined by the client device 110 accelerometer, and/or using other methods such as BLE RSSI measurements), the client device 110 and/or AP 105 may dynamically adjust the frequency and/or duration of ranging intervals. For example, a client device 110 which is moving slowly (e.g., below a first threshold) may not need to have its location reevaluated at an aggressive cycle. Therefore, in some embodiments, slow-moving client devices 110 may increase the interval between ranging operations (e.g., range less frequently) in order to preserve battery life.

In some embodiments, a fast-moving client device 110 may determine that its location is changing quickly. In some embodiments, when either the infrastructure or the client device 110 determines an increasing or high rate of motion (e.g., above a threshold), system may increase the ranging frequency in proportion to the motion. In some embodiments, as the client device 110 slows down, the ranging frequency is also reduced.

In some embodiments, the ranging type or technology may be selected based on the speed and/or range of motion. For example, in some embodiments, if the client device 110 is moving at a relatively fast pace (e.g., above a threshold speed), the client device 110 (or AP 105) may determine to use a relatively coarse technology (e.g. WiFi RSSI-based ranging). That is, the client device 110 may use techniques that result in relatively coarse readings of the device position, but also consume relatively less energy. In some embodiments, although the inferred position of the client device 110 at a first time t may be relatively inaccurate, the client device 110 may use prior and/or subsequent predictions (e.g., from time t+1) to increase the overall accuracy. For example, the client device 110 may use Kalmann filtering).

In some embodiments, as the client device 110 slows down (e.g., if the client device 110 determines that the movement is below a defined speed), more accurate position may be useful. In some embodiments, therefore, the client device 110 may enable one or more other radios or ranging techniques (e.g., using BLE first, then switching to UWB-based ranging when the client device 110 speed drops below a threshold) to obtain a finer reading of the client device 110 position (which may consume more energy or power).

In some embodiments, in addition to or instead of selecting ranging parameters based on motion of the client device 110, one or more client devices 110 and/or APs 105 may use a variety of environment-constraint-aware and/or location-based evaluations. For example, in some embodiments, different ranging technologies may work better (e.g., returning more accurate results) in different physical environments. For example, in open areas, UWB-based ranging may work well. However, in smaller or confined spaces, other techniques such as BLE-based ranging may return better results. Thus, in some embodiments, the client device 110 and/or AP 105 may determine or select a ranging mechanism or technology that is likely to return the most accurate location resolution, based on the physical geometry and context of a location.

In some embodiments, the client device 110 and/or AP 105 may be aware of the various ranging capabilities available. However, certain ranging systems (such as UWB-based ranging) may be most useful or accurate when they are within range of a sufficient number of APs 105.

In some embodiments, therefore, the client device 110 and/or AP(s) 105 may determine if a sufficient number of anchors are within range to perform accurate UWB-based ranging (e.g., using time difference of arrival (TDOA)). If not, then the client device 110 and/or AP 105 may determine to refrain from using such ranging technologies, selecting an alternate mechanism instead (such as AoA, which is generally less accurate but still returns good results in some scenarios). In this way, an intelligent selection of the best ranging technique can be used to save battery life of a client device 110 without wasting energy on ranging techniques that are unlikely to return high quality resolution.

In some embodiments, in addition to or instead of evaluating which AP(s) 105 area within range, the infrastructure (e.g., an AP 105 and/or controller) may provide a mapping indicating, for each general zone or location in the physical space, a hierarchy of ranging techniques that client devices 110 should use (e.g., sorted by expected accuracy results). In some embodiments, the client device 110 makes this determination dynamically. For example, a client device 110 may determine its position using several ranging techniques, and evaluate the reliability or accuracy of each technique attempted (e.g., by measuring the variance of each measurement technique over time, by measuring the noise and/or stress of each matrix formed, and the like). In some embodiments, techniques which perform below a configurable threshold may be disabled for a configurable time interval, leaving the client device 110 to use the most efficient ranging technique(s) in the given area. In some embodiments, the client device 110 may report its location and ranging results (e.g., to the infrastructure) to update the mapping(s) used to indicate preferred ranging techniques for each region or location.

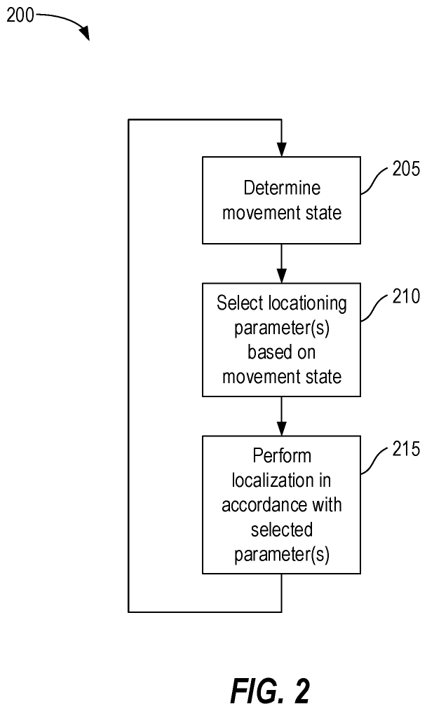

FIG. 2 is a flow diagram depicting an example method 200 for selecting parameters for efficient ranging and localization, according to some embodiments of the present disclosure. In some embodiments, the method 200 is performed by a ranging device. In some embodiments, a “ranging device” may refer to any computing device that uses one or more ranging techniques to determine the distance to and/or location of itself and/or of one or more other devices. For example, the ranging device may correspond to a client device (such as the client devices 110 of FIG. 1), an AP or other anchor (such as the APs 105 of FIG. 1), and the like.

At block 205, the ranging device determines a movement state (also referred to in some aspects as movement information) for a client device (which may, itself, by the ranging device). As discussed above, the movement information or state may generally include a variety of information, such as whether the client device is in motion, the speed or velocity of movement, the direction of movement, the acceleration of the client device, the current and/or predicted future location of the client device, and the like. Further, as discussed above, determining the movement state may be performed using a variety of operations and technologies. For example, in some embodiments, the ranging device may evaluate accelerometer data from one or more accelerometers of the client device. In some embodiments, the ranging device may evaluate ranging information (e.g., to determine whether the range from the client device to one or more anchor devices is changing over time). In some embodiments, the ranging device may evaluate environmental data such as detected temperature changes, wind speed, and the like in order to infer movement. In some embodiments, if the ranging device is an AP, the ranging device may detect or infer movement based on receiving a ranging frame or request from the client device (e.g., for clients that only range when in motion), and/or based on receiving a management or control frame indicating the movement.

At block 210, the ranging device selects one or more locationing parameters (also referred to as ranging parameters, as discussed above) based on the movement state. As discussed above, the locationing parameters may be selected based on a set of rules or mappings configured to balance resource consumption (e.g., battery power of the client device, bandwidth of the network, and the like) with desired accuracy or reliability of the ranging. For example, if the movement state indicates that the client device is not moving, the ranging device may determine to use a relatively low-power consuming ranging technique (e.g., ranging to a single anchor, or using a less accurate low power alternative). As another example, if the movement state indicates that the client device is slowing down (e.g., it was moving, and is approaching its destination), the ranging device may determine to use a relatively higher precision ranging technique (which may consume more power). As discussed above, there are a wide variety of locationing parameters that can be selected to controlled, including switching which ranging technique to use, selecting a ranging frequency to use, and the like.

At block 215, the ranging device performs or facilitates localization for the client device in accordance with the selected parameter(s). For example, as discussed above, the ranging device may initiate and/or respond to ranging requests to and/or from one or more anchor AP devices. As another example, the ranging device may evaluate characteristics of received signals, such as RSSI, AoA, AoD, TDoA, ToF, and the like in order to perform the localization. Generally, the particular operations used to perform localization may vary depending on the particular technology and parameter(s) selected, as discussed above. In some aspects, as discussed above, performing localization may include performing ranging to one or more APs with known locations in order to estimate or infer the location of the client device.

The method 200 then returns to block 205. In some embodiments, the method 200 is performed each time ranging is requested or desired for the client device. For example, each time an application on the client device requests localization (or each time the infrastructure requests localization of the client device), the ranging device may perform the method 200 to select corresponding localization parameters. In some embodiments, as discussed above, the method 200 may be performed relatively continuously or on a defined schedule (e.g., every few seconds). In some embodiments, as discussed above, the method 200 is performed in response to the detection of various events, such as movement. That is, the ranging device may perform the method 200 in response to determining that the client device has started moving (or is otherwise in motion) and/or in response to determining that the movement of the client device is changing (e.g., speeding up, slowing down, coming to a stop, and the like).

Advantageously, using the method 200 to select localization parameters based at least in part on movement information for the client device, the ranging device is able to reduce the resource consumption of the client device to perform localization (e.g., reducing power consumption, such as from a battery of the client device) while maintaining acceptable or high-quality ranging results (e.g., results that are sufficiently accurate for the given use case of the client device, given its movement state).

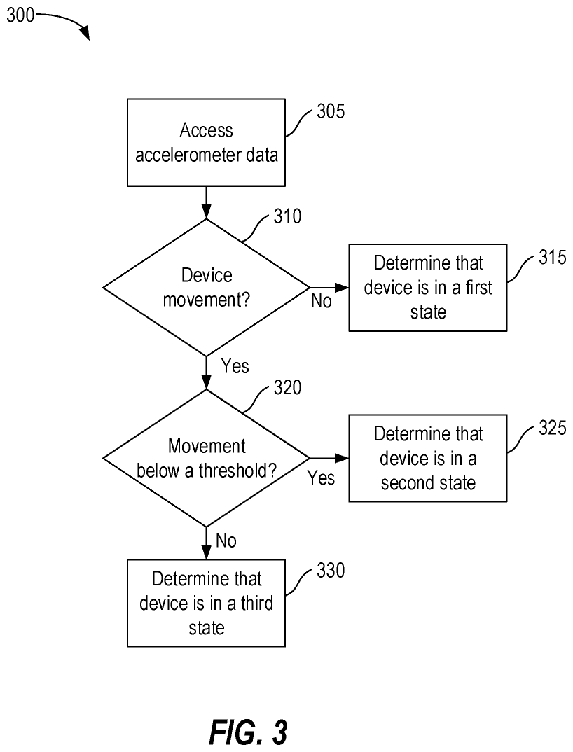

FIG. 3 is a flow diagram depicting an example method 300 for evaluating accelerometer data to select efficient ranging parameters, according to some embodiments of the present disclosure. In some embodiments, the method 300 is performed by a ranging device (e.g., client device such as the client devices 110 of FIG. 1, an AP or other anchor such as the APs 105 of FIG. 1, and the like). In some embodiments, the method 300 provides additional detail for block 205 of FIG. 2.

At block 305, the ranging device accesses accelerometer data of the client device. For example, as discussed above, the client device may include one or more accelerometers (e.g., a multi-axis accelerometer) which can be used for a variety of tasks, including movement detection. As used herein, “accessing” data can generally include receiving, requesting, retrieving, measuring, collecting, obtaining, or otherwise gaining access to the data. In some embodiments, if the ranging device is the client device, the ranging device measures or collects the accelerometer data using the on-device components. In some embodiments, if the ranging device is an AP or other infrastructure device, the ranging device may receive the ranging data in one or more management frames from the client device.

At block 310, the ranging device determines whether the client device is moving, based on the accelerometer data. If not, the method 300 continues to block 315, where the ranging device determines that the device is in a first state (e.g., a stationary state). In some aspects, as discussed above, this first state may correspond to a first set of localization parameters, such as a reduced ranging frequency, ranging to a reduced set of anchors (e.g., a single AP), using a less accurate (and lower power consumption) ranging technique such as BLE-based RSSI techniques, refraining from ranging altogether, and the like.

Returning to block 310, if the ranging device determines that the device is in motion, the method 300 continues to block 320. At block 320, the ranging device determines whether the movement is below a threshold. For example, the ranging device may determine the speed and/or acceleration of the movement to compare the movement against one or more speed and/or acceleration thresholds. If the movement is below the threshold (e.g., sufficiently slow), the method 300 continues to block 325, where the ranging device determines that the device is in a second state (e.g., a slow movement state). In some embodiments, as discussed above, this second state may correspond to a second set of localization parameters, such as a somewhat higher ranging frequency (as compared to the first state), ranging to an increased number of anchors (as compared to the first state), using a somewhat more accurate (and somewhat higher power consumption) technique such as UWB-based ranging (as compared to the first state), and the like.

Returning to block 320, if the ranging device determines that the movement is not below the threshold(s) (e.g., that the device is moving sufficiently quickly), the method 300 continues to block 330, where the ranging device determines that the client device is in a third state (e.g., a rapid movement state). In some embodiments, as discussed above, this third state may correspond to a third set of localization parameters, such as a different ranging frequency (as compared to the first and second states), which may be higher or lower than the other states, ranging to a different number of anchors (which may include more or fewer anchors), using a different technique (which may include more accurate techniques or less accurate techniques), and the like.

Although the illustrated example depicts three discrete states, in some aspects, the ranging device may use additional states (e.g., multiple tiered movement speed thresholds) and/or continuous mappings. For example, rather than mapping from a discrete movement speed to a set of localization parameters, the ranging device may use an algorithm that generates parameters based on the movement characteristics (e.g., that scales the ranging frequency up and down in proportion to the movement speed).

In some embodiments, the particular localization parameters that correspond to each state may vary depending on the particular use case and/or client device. For example, some client devices may be configured to reduce ranging or use less accurate techniques when moving quickly (e.g., in the third state), while other client devices may be configured to increase ranging or use more accurate techniques when moving quickly.

Advantageously, using the method 300 to determine movement states, the ranging device is able to reduce the resource consumption of the client device to perform localization (e.g., reducing power consumption, such as from a battery of the client device) while maintaining acceptable or high-quality ranging results (e.g., results that are sufficiently accurate for the given use case of the client device, given its movement state).

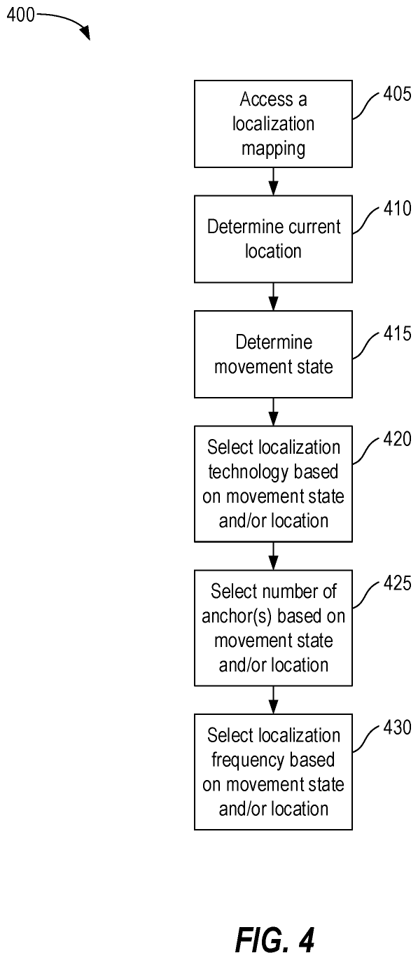

FIG. 4 is a flow diagram depicting an example method 400 for location-based ranging parameter selection, according to some embodiments of the present disclosure. In some embodiments, the method 400 is performed by a ranging device (e.g., client device such as the client devices 110 of FIG. 1, an AP or other anchor such as the APs 105 of FIG. 1, and the like). In some embodiments, the method 400 provides additional detail for block 210 of FIG. 2.

At block 405, the ranging device accesses a localization mapping for the physical location or AP deployment. In some embodiments, as discussed above, the mapping may indicate, for one or more locations or regions in the space, a set of preferred ranging techniques or other localization parameters. For example, the mapping may indicate that an RSSI-based technique works well for one region, while performing poorly in a second region. In some embodiments, the ranging device accesses the localization mapping from an infrastructure device. For example, the AP(s) (or other devices in the infrastructure) may build and/or maintain the mappings, and provide them (e.g., upon request) to ranging devices. In some embodiments, the client device(s) may build and/or maintain the mappings locally.

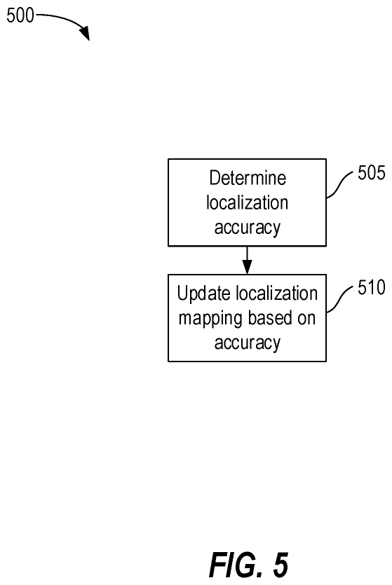

In some embodiments, thee localization mapping is generated based at least in part on the physical geometry and/or material properties of the space (e.g., using wireless signal simulations based on the presence and arrangement of objects in the room). In some embodiments, the localization mapping may be generated based at least in part on historical ranging data. For example, when localization is performed, the ranging device may monitor or determine the resulting accuracy (e.g., based on variance over time or other factors), and update the mappings to indicate the relative accuracy of each technique for various locations or regions in the space. One example method for generating the mapping is discussed in more detail below with reference to FIG. 5.

At block 410, the ranging device determines a current location of the client device. For example, in some embodiments, the ranging device may facilitate or perform one or more localization operations at a first time to determine or infer the location of the client (e.g., which region in the space).

At block 415, the ranging device determines the movement state of the client device. For example, as discussed above, the ranging device may determine whether the client device is moving, the velocity of movement, the acceleration of movement, and the like.

At block 420, the ranging device selects one or more localization technologies (e.g., from a set of alternatives that the client device can perform) based on the movement state and/or location information, as discussed above.

At block 425, the ranging device selects a number of anchor(s) to use for the localization of the client device based on the movement state and/or location information, as discussed above.

At block 430, the ranging device selects a localization frequency (e.g., how often to perform localization) based on the movement state and/or location information, as discussed above.

Advantageously, using the method 400 to determine movement states and localization mappings, the ranging device is able to reduce the resource consumption of the client device to perform localization (e.g., reducing power consumption, such as from a battery of the client device) while maintaining acceptable or high-quality ranging results (e.g., results that are sufficiently accurate for the given use case of the client device, given its location and/or movement state).

FIG. 5 is a flow diagram depicting an example method 500 for refining ranging mappings, according to some embodiments of the present disclosure. In some embodiments, the method 500 is performed by a ranging device (e.g., client device such as the client devices 110 of FIG. 1, an AP or other anchor such as the APs 105 of FIG. 1, and the like). In some embodiments, the method 500 provides additional detail for block 405 of FIG. 4.

At block 505, the ranging device determines localization accuracy of one or more localization techniques (or set of localization parameters) for a client device. For example, as discussed above, the ranging device may use multiple sets of parameters to perform multiple localization operations, and evaluate the relative accuracy of each alternative set of parameters.

At block 510, the ranging device updates a localization mapping based on the determined accuracy of each technique or set of parameters. For example, as discussed above, the ranging device may generate an ordered list of techniques (or parameters) based on the accuracy of each. In some embodiments, updating the mapping includes indicating the relative accuracies for the specific location where the client device is located. In this way, for future ranging, the client device (or other devices) can infer or predict which set(s) of parameters will result in accurate results, and which should be avoided. This information, combined with movement information as discussed above, may enable efficient localization for the client device.

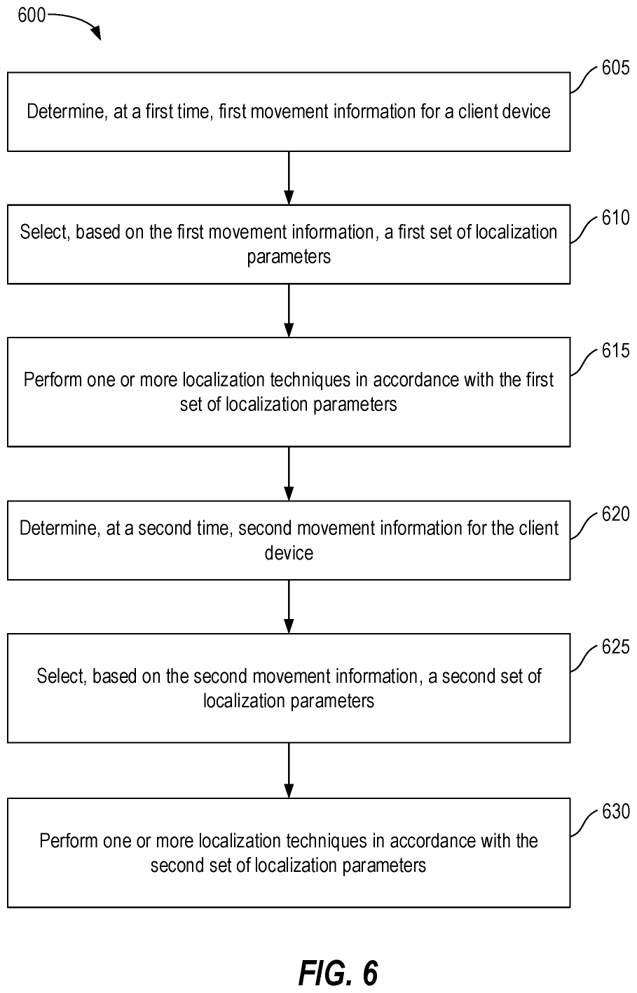

FIG. 6 is a flow diagram depicting an example method 600 for performing localization, according to some embodiments of the present disclosure. In some embodiments, the method 600 is performed by a ranging device (e.g., client device such as the client devices 110 of FIG. 1, an AP or other anchor such as the APs 105 of FIG. 1, and the like).

At block 605, first movement information for a client device (e.g., the client device 105 of FIG. 1) is determined at a first time.

At block 610, a first set of localization parameters is selected based on the first movement information.

At block 615, one or more localization techniques are performed in accordance with the first set of localization parameters.

At block 620, second movement information for the client device is determined at a second time.

At block 625, a second set of localization parameters is selected based on the second movement information.

At block 630, one or more localization techniques are performed in accordance with the second set of localization parameters.

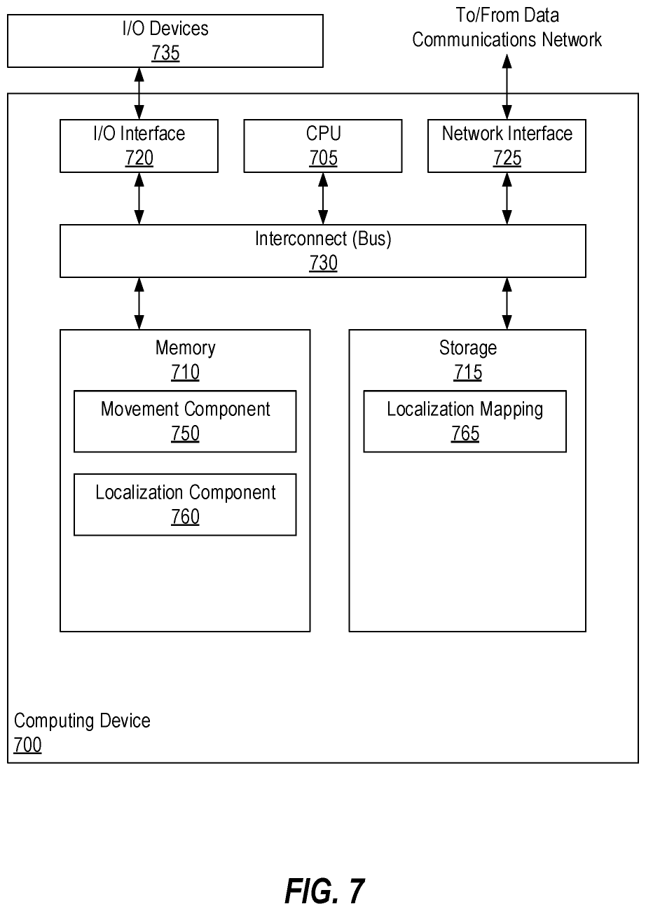

FIG. 7 depicts an example computing device configured to perform various aspects of the present disclosure, according to some embodiments of the present disclosure. Although depicted as a physical device, in embodiments, the computing device 700 may be implemented using virtual device(s), and/or across a number of devices (e.g., in a cloud environment). In one embodiment, the computing device 700 corresponds to a client device (e.g., a client device 110 of FIG. 1), an AP (e.g., an AP 105 of FIG. 1), and/or to a wireless controller that controls one or more APs.

As illustrated, the computing device 700 includes a CPU 705, memory 710, storage 715, a network interface 725, and one or more I/O interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 includes a movement component 750 and a localization component 760, which may perform one or more embodiments discussed above. Although depicted as discrete components for conceptual clarity, in embodiments, the operations of the depicted components (and others not illustrated) may be combined or distributed across any number of components. Further, although depicted as software residing in memory 710, in embodiments, the operations of the depicted components (and others not illustrated) may be implemented using hardware, software, or a combination of hardware and software.

The movement component 750 may generally be used to determine or infer movement information of one or more client devices. For example, the movement information may indicate whether the client device is moving, the movement speed and/or direction, the acceleration, the current and/or predicted future location of the device, and the like. In some embodiments, as discussed above, the movement component 750 may determine the device movement based on accelerometer data, temperature data, wind speed data, ranging data, and the like.

The localization component 760 may generally be used to select localization parameters and perform localization operations, as discussed above. For example, the localization component 760 may evaluate the movement information to select an optimized set of localization parameters (e.g., based on one or more rules, mappings, or algorithms) to balance localization accuracy with power consumption. In some embodiments, the localization component 760 may further evaluate localization mappings (e.g., indicating relative localization accuracies), as discussed above. The localization component 760 may then perform or engage in localization for the client device in accordance with the parameters (e.g., at the determined frequency, using the determined technique(s), to the determined number of anchor(s), and the like).

In the illustrated example, the storage 715 includes a localization mapping 765. As discussed above, the localization mapping 765 may generally indicate the relative accuracies of one or more sets of locationing parameters (e.g., different technologies) for one or more regions or locations in a deployment space. In some embodiments, as discussed above, the localization component 760 may update the localization mapping 765 based on its determined accuracy during use.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
determining, at a first time, first movement information for a client device;
selecting, based on the first movement information, a first set of localization parameters;
performing one or more localization techniques in accordance with the first set of localization parameters;
determining, at a second time, second movement information for the client device;
selecting, based on the second movement information, a second set of localization parameters; and
performing one or more localization techniques in accordance with the second set of localization parameters.

2. The method of claim 1, wherein:
the first movement information indicates that the client device is moving below a threshold, and
performing the one or more localization techniques in accordance with the first set of localization parameters comprises using a first localization technique that consumes less energy, as compared to a second localization technique.

3. The method of claim 2, wherein:
the second movement information indicates that the client device is moving above the threshold, and
performing the one or more localization techniques in accordance with the second set of localization parameters comprises using the second localization technique.

4. The method of claim 1, wherein:
the first movement information indicates that the client device is not moving,
performing the one or more localization techniques in accordance with the first set of localization parameters comprises performing ranging to a single ranging anchor device,
the second movement information indicates that the client device is moving, and
performing the one or more localization techniques in accordance with the second set of localization parameters comprises performing ranging to a plurality of ranging anchor devices.

5. The method of claim 1, wherein
the first movement information indicates that the client device is moving below a threshold,
performing the one or more localization techniques in accordance with the first set of localization parameters comprises performing ranging at a first frequency,
the second movement information indicates that the client device is moving above the threshold, and
performing the one or more localization techniques in accordance with the second set of localization parameters comprises performing ranging at a second frequency that is higher than the first frequency.

6. The method of claim 1, wherein performing the one or more localization techniques in accordance with the second set of localization parameters comprises transmitting, to a network device, an indication that the client device is moving.

7. The method of claim 6, wherein the network device determines to perform ranging to the client device based on the indication.

8. The method of claim 1, further comprising:
determining, at the second time, a location of the client device in a physical space; and
selecting the second set of localization parameters based further on the location.

9. The method of claim 8, further comprising:
determining an accuracy of the one or more localization techniques performed in accordance with the second set of localization parameters; and
updating, based on the accuracy, a mapping between locations in the physical space and localization parameters.

10. The method of claim 1, wherein the first movement information is determined using an accelerometer of the client device.

11. One or more non-transitory computer-readable media comprising computer-executable instructions that, when executed by one or more processors of a processing system, cause the processing system to perform an operation comprising:
determining, at a first time, first movement information for a client device;
selecting, based on the first movement information, a first set of localization parameters;
performing one or more localization techniques in accordance with the first set of localization parameters;
determining, at a second time, second movement information for the client device;
selecting, based on the second movement information, a second set of localization parameters; and
performing one or more localization techniques in accordance with the second set of localization parameters.

12. The one or more non-transitory computer-readable media of claim 11, wherein:
the first movement information indicates that the client device is moving below a threshold, and
performing the one or more localization techniques in accordance with the first set of localization parameters comprises using a first localization technique that consumes less energy, as compared to a second localization technique.

13. The one or more non-transitory computer-readable media of claim 11, wherein:
the first movement information indicates that the client device is not moving,
performing the one or more localization techniques in accordance with the first set of localization parameters comprises performing ranging to a single ranging anchor device,
the second movement information indicates that the client device is moving, and
performing the one or more localization techniques in accordance with the second set of localization parameters comprises performing ranging to a plurality of ranging anchor devices.

14. The one or more non-transitory computer-readable media of claim 11, wherein
the first movement information indicates that the client device is moving below a threshold,
performing the one or more localization techniques in accordance with the first set of localization parameters comprises performing ranging at a first frequency,
the second movement information indicates that the client device is moving above the threshold, and
performing the one or more localization techniques in accordance with the second set of localization parameters comprises performing ranging at a second frequency that is higher than the first frequency.

15. The one or more non-transitory computer-readable media of claim 11, wherein performing the one or more localization techniques in accordance with the second set of localization parameters comprises transmitting, to a network device, an indication that the client device is moving.

16. A system comprising:
one or more computer processors; and
logic encoded in one or more non-transitory media, the logic collectively executable by operation of the one or more computer processors to perform an operation comprising:
determining, at a first time, first movement information for a client device;
selecting, based on the first movement information, a first set of localization parameters;
performing one or more localization techniques in accordance with the first set of localization parameters;
determining, at a second time, second movement information for the client device;
selecting, based on the second movement information, a second set of localization parameters; and
performing one or more localization techniques in accordance with the second set of localization parameters.

17. The system of claim 16, wherein:
the first movement information indicates that the client device is moving below a threshold, and
performing the one or more localization techniques in accordance with the first set of localization parameters comprises using a first localization technique that consumes less energy, as compared to a second localization technique.

18. The system of claim 16, wherein:
the first movement information indicates that the client device is not moving,
performing the one or more localization techniques in accordance with the first set of localization parameters comprises performing ranging to a single ranging anchor device,
the second movement information indicates that the client device is moving, and
performing the one or more localization techniques in accordance with the second set of localization parameters comprises performing ranging to a plurality of ranging anchor devices.

19. The system of claim 16, wherein
the first movement information indicates that the client device is moving below a threshold,
performing the one or more localization techniques in accordance with the first set of localization parameters comprises performing ranging at a first frequency,
the second movement information indicates that the client device is moving above the threshold, and
performing the one or more localization techniques in accordance with the second set of localization parameters comprises performing ranging at a second frequency that is higher than the first frequency.

20. The system of claim 16, wherein performing the one or more localization techniques in accordance with the second set of localization parameters comprises transmitting, to a network device, an indication that the client device is moving.
